(19) United States
(12) Patent Application Publication
(10) Pub. No.: US 2007/0009655 A1
(43) Pub. Date: Jan. 11, 2007

(54) METHOD OF MANUFACTURING A MAGNETIC RECORDING MEDIUM

(75) Inventors: Katsuhiko YAMAZAKI, Tokyo (JP); Tsutomu IDE, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 11/428,659

(22) Filed: Jul. 5, 2006

(30) Foreign Application Priority Data
Jul. 5, 2005 (JP) 2005/196407

(51) Int. Cl. B05D 5/12

(52) U.S. Cl. 427/127

(57) ABSTRACT

A method of manufacturing a magnetic recording medium comprising forming a reinforcing layer on a first surface of a non-magnetic support, performing a surface treatment that applies external energy to a surface of the reinforcing layer, and forming a functional layer on the surface of the reinforcing layer that has been subjected to the surface treatment. By doing so, the functional layer can be prevented from peeling off the reinforcing layer with no increase in manufacturing cost or fall in manufacturing yield.

### BACKGROUND OF THE INVENTION

1. Field of the Invention

The present invention relates to a method of manufacturing a magnetic recording medium where a reinforcing layer and functional layers are formed in the mentioned order on a non-magnetic support.

2. Description of the Related Art

In recent years, the track pitch of magnetic recording media has been made narrower to increase the recording density. When doing so, a major issue for such magnetic recording media is how to suppress fluctuations in dimensions (in particular, fluctuations in dimensions in the width direction of the medium), or in other words, how to maintain high dimensional stability. According to a magnetic recording medium (i.e., magnetic tape) disclosed by Japanese Laid-Open Patent Publication No. 2003-132525, dimensional stability is improved by forming a reinforcing layer on at least one surface of a non-magnetic support and then forming functional layers such as a magnetic layer and a back coat layer on top of the reinforcing layer. According to this magnetic recording medium, at least one of a metal, a semimetal, an alloy, a metal oxide, a semimetal oxide, an oxide of an alloy, and a mixture of these is used as the material of the reinforcing layer.

However, by investigating the conventional magnetic recording medium described above in detail, the present inventors found that the adhesion between the reinforcing layer and the function layers formed thereupon is insufficient, resulting in the risk of the functional layers peeling off (i.e., coming away from) the reinforcing layer. For such magnetic recording medium, a method of manufacturing that forms an adhesion-enhancing layer on the reinforcing layer and forms the functional layers on the adhesion-enhancing layer to increase the bonding strength between the reinforcing layer and the functional layers could conceivably be used, but since in reality it is extremely difficult to handle and manage the adhesive that forms the adhesion-enhancing layer, there are the problems of increased manufacturing cost and a fall in manufacturing yield.

### SUMMARY OF THE INVENTION

The present invention was conceived to solve the problem described above, and it is a principal object of the present invention to provide a method of manufacturing a magnetic recording medium that can form functional layers on a reinforcing layer with sufficient bonding strength but without leading to an increase in manufacturing cost or a fall in manufacturing yield.

A method of manufacturing a magnetic recording medium according to the present invention comprises forming a reinforcing layer on a first surface of a non-magnetic support, performing a surface treatment that applies external energy to a surface of the reinforcing layer, and forming a functional layer on the surface of the reinforcing layer that has been subjected to the surface treatment.

In this method of manufacturing a magnetic recording medium, by carrying out a surface treatment that applies external energy to the surface of the reinforcing layer formed on the non-magnetic support and forming a functional layer on the surface of the reinforcing layer that has been subjected to the surface treatment, it is possible to sufficiently improve the bonding characteristics between the reinforcing layer and the functional layer without forming an adhesion-enhancing layer between the reinforcing layer and the functional layer. This means that it is possible to manufacture a magnetic recording medium where the functional layer has been formed on the reinforcing layer with sufficient bonding strength without an increase in manufacturing cost or a fall in manufacturing yield.

In the method of manufacturing a magnetic recording medium, after a back coat layer has been formed as the functional layer, another functional layer may be formed on a second surface of the non-magnetic support. That is, when a plurality of functional layers including a back coat layer are formed on the non-magnetic support, the back coat layer is formed first. By doing so, if a process that temporarily winds the non-magnetic support onto a winding roll is carried out after the reinforcing layer has been formed, for example, since other functional layers have not yet been formed on the non-magnetic support, even if a lubricant is included in the other functional layers, it is possible to reliably prevent the lubricant from adhering to the surface of the reinforcing layer. Since it is possible to avoid a situation where the lubricant makes the surface treatment that subsequently applies external energy to the reinforcing layer less effective (i.e., where the lubricant reduces the improvement in binding characteristics), the back coat layer can be attached to the reinforcing layer with sufficient bonding strength.

With the above method of manufacturing a magnetic recording medium, the reinforcing layer may be formed using at least one of Al, Cu, Zn, Sn, Ni, Ag, Co, Fe, Mn, and Cr as metals, an oxide of the metals, Si, Ge, As, Sc, and Sb as semimetals, and an oxide of the semimetals. By doing so, it is possible to sufficiently achieve the function of the reinforcing layer, that is, the function of improving the dimensional stability of the magnetic recording medium.

With the above method of manufacturing a magnetic recording medium, the reinforcing layer may be formed using aluminum oxide as the oxide of the metals. By doing so, the reinforcing layer can be formed easily and at low cost.

With the above method of manufacturing a magnetic recording medium, after the reinforcing layer has been formed by a vapor phase growth method, the surface treatment may be carried out on the reinforcing layer by carrying out one of corona discharge treatment, plasma treatment, UV beam treatment, and electron beam treatment. By doing so, it is possible to reliably improve the bonding characteristics of the surface of the reinforcing layer even when the reinforcing layer has been formed by the vapor phase growth method.

Another method of manufacturing a magnetic recording medium according to the present invention comprises forming reinforcing layers on both surfaces of a non-magnetic support, performing a surface treatment that applies external energy on a surface of a reinforcing layer formed on at least a first surface out of both surfaces of the non-magnetic support, and forming a functional layer on the surface of the reinforcing layer that has been subjected to the surface treatment. By doing so, stress due to the respective reinforcing layers cancels out, making it possible to reduce curling of the magnetic recording medium and to effectively suppress the permeation of moisture into the non-magnetic support. Also, by carrying out a surface treatment that applies external energy to the surface of the reinforcing layer formed on at least the first surface of the non-magnetic support and forming a functional layer on the surface of the reinforcing layer subjected to the surface treatment, it is possible to sufficiently improve the bonding characteristics between the reinforcing layer and the functional layer without forming an adhesion-enhancing layer between the reinforcing layer and the functional layer.

Also, with the method of manufacturing a magnetic recording medium described above, after a back coat layer has been formed as the functional layer, another functional layer may be formed on a surface of the reinforcing layer formed on a second surface of the non-magnetic support. By doing so, in the same way as the method of manufacturing a magnetic recording medium described above that forms a reinforcing layer on only one surface of the magnetic recording medium, if a process that temporarily winds the non-magnetic support onto a winding roll is carried out after the reinforcing layers have been formed, for example, since other functional layers have not yet been formed on the non-magnetic support, even if a lubricant is included in the other functional layers, it is possible to reliably prevent such lubricant from adhering to the surface of the reinforcing layer. Since it is possible to avoid a situation where the lubricant makes the surface treatment that subsequently applies external energy to the reinforcing layers less effective (i.e., where the lubricant reduces the improvement in bonding characteristics), the back coat layer can be attached to the reinforcing layer with sufficient bonding strength.

It should be noted that the disclosure of the present invention relates to a content of Japanese Patent Application 2005-196407 that was filed on 5 Jul. 2005 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a cross-sectional view of a magnetic tape that is one example of a magnetic recording medium;

FIG. 2 is a cross-sectional view of a magnetic tape that is another example of a magnetic recording medium according to the present invention;

FIG. 3 is an evaluation results table showing the evaluation results for the bonding strength of a number of examples and comparative examples; and

FIG. 4 is a diagram useful in explaining a method of evaluating peel strength.

### DESCRIPTION OF THE PREFERRED EMBODIMENTS

Preferred embodiments of a method of manufacturing a magnetic recording medium according to the present invention will now be described with reference to the attached drawings.

First, the construction of a magnetic tape 1 that is one example of a magnetic recording medium manufactured by the method of manufacturing a magnetic recording medium according to the present invention will be described with reference to the drawings.

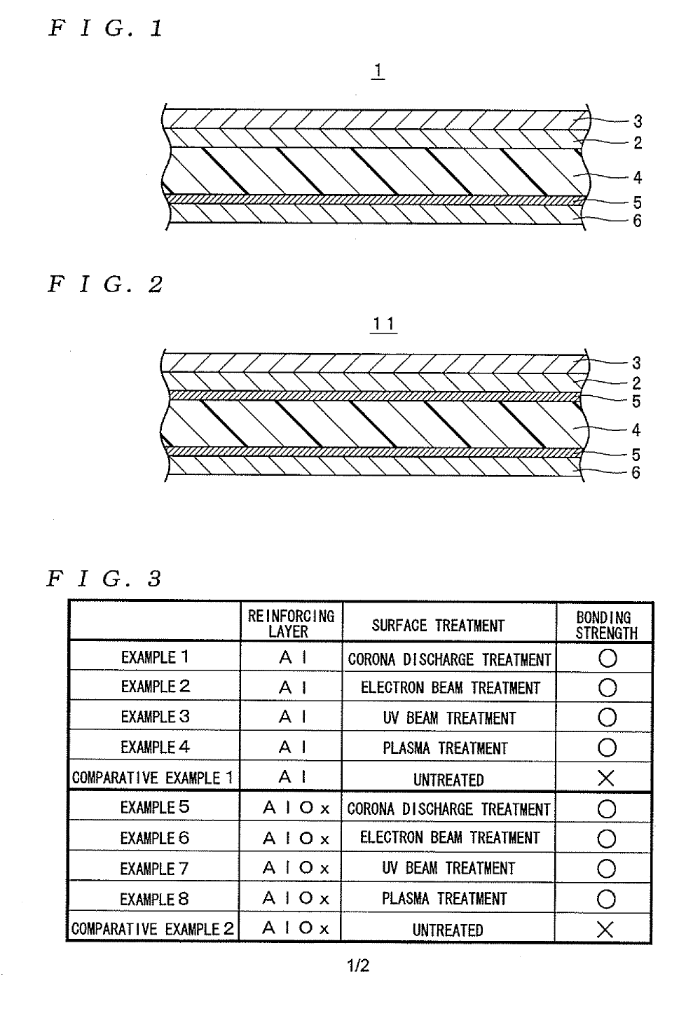

A magnetic tape 1 shown in FIG. 1 has a non-magnetic layer 2 and a magnetic layer 3 (both correspond to “functional layers” for the present invention) formed in the mentioned order on a surface (corresponding to “a second surface” for the present invention: the upper surface in FIG. 1) of a base film 4 (corresponding to a “non-magnetic support” for the present invention), and is constructed so that various types of data can be recorded and reproduced by a recording/reproducing apparatus, not shown. A reinforcing layer 5 and a back coat layer 6 are formed in the mentioned order on an opposite surface (corresponding to “a first surface” for the present invention: the lower surface in FIG. 1) of the base film 4. The reinforcing layer 5 functions so as to improve the dimensional stability of the magnetic tape 1. The back coat layer 6 improves the running characteristics of the tape and prevents the magnetic tape 1 from becoming electrically charged. Note that in FIG. 1, for ease of understanding the present invention, the thickness of the magnetic tape 1 has been exaggerated and the ratio of thicknesses of the various layers has been shown differently to the actual ratio.

Base Film

The base film 4 is formed in a long belt-like form using a resin material such as polyester (for example, polyethylene terephthalate (PET) or polyethylene naphthalate (PEN)), polyolefin (for example, polypropylene), polyamide, polyimide, polyamide-imide, polysulfone-cellulose triacetate, and polycarbonate. In this case, after the various layers have been formed, the base film 4 and the layers are cut out into predetermined widths that are set for various types of magnetic recording media. To make it possible to increase the recording capacity, the thickness of the base film 4 should preferably be set in a range of 3.0 μm to 10.0 μm, inclusive. Note that although the base film 4 is formed in a long belt-like form (a tape) in the present embodiment, the base film 4 may be formed in a variety of shapes such as a sheet, a card, or a disc.

Non-Magnetic Layer

The non-magnetic layer 2 may be a well-known non-magnetic layer, and is not subject to any particular limitations. In the present embodiment, as one example, the non-magnetic layer 2 is formed by applying a non-magnetic coating composition fabricated so as to include nonmagnetic powder and an electron beam-curing binder so that the thickness of the non-magnetic layer 2 is in a range of 0.3 μm to 2.5 μm, inclusive. Here, in a state where the thickness of the non-magnetic layer 2 is below 0.3 μm, the non-magnetic layer 2 is susceptible to being affected by the surface roughness of the base film 4, resulting in deterioration in the smoothness of the surface of the non-magnetic layer 2 and in turn a tendency for deterioration in the smoothness of the surface of the magnetic layer 3. As a result, the electromagnetic conversion characteristics deteriorate and it becomes difficult to record data properly. Also, since the light transmission increases, it becomes difficult to detect the end of the magnetic tape 1 by detecting a change in light transmission. On the other hand, even if the non-magnetic layer 2 is formed with a thickness of over 2.5 μm, there will be no great improvement in the recording characteristics of the magnetic tape 1 and conversely it becomes difficult to form the non-magnetic layer 2 with a uniform thickness. In addition, since a large amount of non-magnetic coating composition will be used to form the non-magnetic layer 2, there is the risk of an increase in manufacturing cost.

As the non-magnetic powder, it is possible to use carbon black or a variety of non-carbon black non-magnetic inorganic powders. As the carbon black, it is possible to use furnace black used in rubber products, thermal black used in rubber products, black used in printing, acetylene black, or the like. Here, the BET specific surface area should preferably be within a range of 5 m²/g to 600 m²/g, inclusive, the DBP oil absorption within a range of 30 ml/100 g to 400 ml/100 g, inclusive, and the average particle diameter in a range of 10 nm to 100 nm, inclusive. The carbon black that can be used can be decided by referring to the “Carbon Black Handbook” (produced by the Carbon Black Association). The proportion of the carbon black in the non-magnetic layer 2 may be in a range of 5% by weight to 30% by weight inclusive, and preferably in a range of 10% by weight to 25% by weight inclusive.

As the non-carbon black non-magnetic inorganic powder, it is possible to use one of acicular non-magnetic iron oxide (such as α-Fe₂O₃ or α-FeOOH), calcium carbonate (CaCO₃), titanium oxide (TiO₂), barium sulfate (BaSO₄) and α-alumina (α-Al₂O₃), or a mixture of such non-magnetic inorganic powders. Also, the mixed proportions of the carbon black and the non-carbon black non-magnetic inorganic powder should preferably be set so that the weight ratio (carbon black: non-magnetic inorganic powder) is in a range of 30:70 to 5:95, inclusive. Here, if the proportion of carbon black is below 5 parts by weight, there are problems such as the non-magnetic layer 2 having high surface electrical resistance and the light transmission becoming high.

Examples of the electron-beam curing binder include resins such as polyurethane resin, (meth)acrylic resin, polyester resin, vinyl chloride copolymer (such as vinyl chloride-epoxy-based copolymer, vinyl chloride-vinyl acetate-based copolymer, or vinyl chloride-vinylidene chloride copolymer), acrylonitrile-butadiene-based copolymer, polyamide resin, polyvinyl butyral-based resin, nitrocellulose, styrene-butadiene-based copolymer, polyvinyl alcohol resin, acetal resin, epoxy-based resin, phenoxy-based resin, polyether resin, polyfunctional polyether such as polycaprolactone, polyamide resin, polyimide resin, phenol resin, and polybutadiene elastomer that have been altered so as to become curable by an electron beam. As one example, a vinyl chloride-based copolymer and polyurethane resin are used as the electron-beam curing binder of the magnetic tape 1 (the non-magnetic layer 2).

As the vinyl chloride-based copolymer, a copolymer including 40% by weight to 95% by weight inclusive of vinyl chloride may be used, with a copolymer including 50% by weight to 90% by weight inclusive of vinyl chloride being more preferable. The average degree of polymerization is preferably in a range of 100 to 500, inclusive. In particular, a copolymer of vinyl chloride and a monomer including an epoxy (glycidyl) group should preferably be used as the vinyl chloride-based copolymer. The vinyl chloride-based copolymer can be altered so as to become curable by an electron beam by introducing a (meth)acrylic double bond or the like using a well-known method. Also, “polyurethane resin” in the present specification is a general name for a resin produced by a reaction between a hydroxy group-containing resin, such as polyester polyol and/or polyether polyol, and a polyisocyanate-containing compound. Such polyurethane resin has a number-average molecular weight of around 5,000 to 200,000, inclusive and a Q value (weight-average molecular weight/number-average molecular weight) of in a range of 1.5 to 4, inclusive. The polyurethane resin may be altered to an electron beam-curing resin by introducing a (meth)acrylic double bond using a well-known method.

The included amount of electron beam-curing binder in the non-magnetic layer 2 should preferably be in a range of 10 parts by weight to 100 parts by weight, inclusive and more preferably in a range of 12 parts by weight to 30 parts by weight, inclusive relative to 100 parts by weight of the total of the carbon black and the non-carbon black non-magnetic inorganic powder in the non-magnetic layer 2. If the included amount of electron beam-curing binder is too small, the proportion of the electron beam-curing binder in the non-magnetic layer 2 falls and sufficient coating film strength is not achieved. On the other hand, if the included amount of binder is too large, in the case of a tape-shaped medium such as a magnetic tape, the tape will be susceptible to becoming prominently bent in the width direction of the tape, resulting in a tendency for poor contact with the magnetic head.

Various well-known resins may be included in the non-magnetic layer 2 in a range of 20% by weight or less of the electron-beam curing binder (the vinyl chloride-based copolymer and polyurethane resin). As one example, to improve the crosslinking of the electron beam-curing binder, as necessary it is possible to include an electron beam-curing polyfunctional monomer as a crosslinking agent, and in such case, polyfunctional (meth)acrylate should preferably be used. There are no particular limitations on the polyfunctional (meth)acrylate used, and ethylene glycol di(meth)acrylate, diethylene glycol di(meth)acrylate, polyethylene glycol di(meth)acrylate, 1,6-hexane glycol di(meth)acrylate, pentaerythritol tetra(meth)acrylate, trimethylol propane tri(meth)acrylate, and trimethylol propane di(meth)acrylate can be given as examples.

In addition, a dispersant such as a surfactant, a lubricant such as a higher fatty acid, a fatty acid ester, and a fatty acid amide, an abrasive, and other additives may be added to the non-magnetic layer 2 as necessary.

The non-magnetic coating composition for forming the non-magnetic layer 2 is prepared using a well-known method where an organic solvent is added to the various substances described above and processes such as mixing, agitating, kneading, and dispersing are carried out. There are no particular limitations on the organic solvent used, and it is possible to select and use one or a mixture of two or more solvents such as ketone solvents (for example, methyl ethyl ketone (MEK), methyl isobutyl ketone, and cyclohexanone) and aromatic solvents (for example, toluene). The added amount of organic solvent can be set in a range of 100 parts by weight to 900 parts by weight, inclusive, relative to 100 parts by weight of the total of the solid content (carbon black, the non-carbon black non-magnetic inorganic powder, and the like) and the electron beam-curing binder (note that the 100 parts by weight includes additives such as a dispersant when such additives are added).

Magnetic Layer

The magnetic layer 3 may be a well-known magnetic layer and is not subject to any particular limitations. In the present embodiment, as one example, by applying a magnetic coating composition fabricated so as to include a ferromagnetic powder and a binder, for example, the magnetic layer 3 is formed with a thickness in a range of 0.03 μm to 0.30 μm, inclusive, and preferably in a range of 0.05 μm to 0.25 μm, inclusive (as one example, around 0.10 μm in the present embodiment). The thickness of the magnetic layer 3 needs to be set in the ranges described above since the self-demagnetization loss and thickness loss become large if the magnetic layer 3 is too thick.

As the ferromagnetic powder, metal magnetic powder or hexagonal plate-shaped fine powder should preferably be used. For the metal magnetic powder, the coercitivity Hc should preferably be in a range of 118.5 kA/m to 237 kA/m (1500 Oe to 3000 Oe), inclusive, the saturation magnetization as in a range of 90 Am²/kg to 160 Am²/kg (emu/g), inclusive, the average major axis length (the average major axis diameter) in a range of 0.03 μm to 0.1 μm, inclusive, the average minor axis length (the average minor axis diameter) in a range of 7 nm to 20 nm, inclusive, and the aspect ratio in a range of 1.2 to 20 inclusive. The coercitivity Hc of a magnetic tape 1 fabricated using metal magnetic powder should preferably be in a range of 118.5 kA/m to 237 kA/m (1500 Oe to 3000 Oe), inclusive. As additive elements for the ferromagnetic powder, according to the intended purpose, it is possible to use Ni, Zn, Co, Al, Si, Y, or another rare earth. For the hexagonal plate-shaped fine powder, the coercitivity Hc should preferably be in a range of 79 kA/m to 237 kA/m (1000 Oe to 3000 Oe), inclusive, the saturation magnetization as in a range of 50 Am²/kg to 70 Am²/kg (emu/g), inclusive, the average plate particle diameter in a range of 30 nm to 80 nm, inclusive, and the plate ratio in a range of 3 to 7, inclusive. The coercitivity Hc of a magnetic tape 1 fabricated using the hexagonal plate-shaped fine powder should preferably be in a range of 94.8 kA/m to 238.7 kA/m (1200 Oe to 3000 Oe) inclusive. As additive elements for the hexagonal plate-shaped fine powder, according to the intended purpose, it is possible to use Ni, Co, Ti, Zn, Sn, or another rare earth.

The ferromagnetic powder may constitute 70% by weight to 90% by weight of the magnetic layer 3 composition. If the included amount of ferromagnetic powder is too large, there will be a fall in the included amount of binder, making the magnetic layer 3 susceptible to deterioration in surface smoothness due to the calendering process. On the other hand, if the included amount of ferromagnetic powder is too little, a high reproduction output cannot be obtained.

There are no particular limitations on the binder used in the magnetic layer 3, and it is possible to use a suitable combination of a thermoplastic resin, a thermosetting or reactive resin, an electron beam-curing binder, and the like in accordance with the properties and processing conditions of the magnetic tape 1.

The included amount of binder used in the magnetic layer 3 is preferably set in a range of 5 parts by weight to 40 parts by weight, and more preferably in a range of 10 parts by weight to 30 parts by weight, relative to 100 parts by weight of the ferromagnetic powder. If the included amount of binder is too small, the strength of the magnetic layer 3 falls, making the magnetic tape 1 susceptible to a fall in running durability. On the other hand, if the included amount of binder is too large, there is a fall in the included amount of ferromagnetic powder, resulting in a tendency for a drop in the electromagnetic conversion characteristics.

Also, to improve the mechanical strength of the magnetic layer 3 and prevent clogging of a magnetic head, the magnetic layer 3 should preferably include an abrasive, such as α-alumina (Mohs hardness=9), with a Mohs hardness of 6 or higher. This type of abrasive normally has an indeterminate form, and in addition to preventing clogging of the magnetic head, makes the magnetic layer 3 stronger.

The average particle diameter of the abrasive may be set in a range of 0.01 μm to 0.2 μm, inclusive, and preferably in a range of 0.05 μm to 0.2 μm, inclusive. If the average particle diameter is too large, the amount by which the abrasive protrudes from the surface of the magnetic layer 3 becomes too large and there is a risk of a fall in the electromagnetic conversion characteristics, an increase in drop outs, an increase in abrasion of the magnetic head, and the like. On the other hand, if the average particle diameter is too small, the amount by which the abrasive protrudes from the surface of the magnetic layer 3 becomes too small and the effect of preventing clogging of the magnetic head becomes insufficient.

The average particle diameter of the abrasive is normally measured using a transmission electron microscope. The included amount of abrasive is set in a range of 3 parts by weight to 25 parts by weight inclusive, and preferably in a range of 5 parts by weight to 20 parts by weight inclusive, relative to 100 parts by weight of the ferromagnetic powder. In addition, a dispersant such as a surfactant, a lubricant such as a higher fatty acid, a fatty acid ester, and silicon oil, or other additives should be added to the magnetic layer 3 as necessary.

The magnetic coating composition for forming the magnetic layer 3 is produced according to a well-known method by adding an organic solvent to the substances described above and carrying out processes such as mixing, agitating, kneading, and dispersing. There are no particular limitations on the organic solvent used, and it is possible to use the same substances used for the non-magnetic layer 2.

The center line average roughness Ra of the surface of the magnetic layer 3 should preferably be set in a range of 1.0 nm to 5.0 nm inclusive and more preferably in a range of 1.0 nm to 4.0 nm inclusive. If the center line average roughness Ra is below 1.0 nm, the surface of the magnetic layer 3 is too smooth, causing deterioration in the running stability and making the magnetic tape 1 susceptible to problems during running. On the other hand, if the center line average roughness Ra exceeds 5.0 nm, the surface of the magnetic layer 3 becomes rough, resulting in the electromagnetic conversion characteristics such as the reproduction output and the like tending to deteriorate.

Reinforcing Layer

The reinforcing layer 5 is provided to improve the dimensional stability of the magnetic tape 1. As the material of the reinforcing layer 5, at least one of a metal, a metal oxide, a semimetal, and a semimetal oxide is used. More specifically, Al, Cu, Zn, Sn, Ni, Ag, Co, Fe, Mn, Cr or the like can be used as metals, and Si, Ge, As, Sc, Sb, or the like can be used as semimetals. By doing so, it is possible to sufficiently achieve the function of the reinforcing layer 5, that is, the function of improving the dimensional stability of the magnetic tape 1. Metal oxides and semimetal oxides can be easily fabricated by introducing oxygen gas during deposition, for example. Aluminum oxide can be given as a representative example of such oxides. Aluminum oxide can be favorably used as the material of the reinforcing layer 5 since aluminum oxide can be easily formed in a film form and can be fabricated at low cost. The reinforcing layer 5 may be composed of a single layer or a plurality of layers.

The reinforcing layer 5 is formed by a vapor phase growth method such as vacuum deposition, sputtering, and ion plating. Since a reinforcing layer formed by such methods does not include a resin binder, it is believed such reinforcing layer will bind weakly to functional layers that include resin. Here, when the reinforcing layer 5 is less than 40 nm thick, it is not possible to sufficiently suppress the permeation of moisture, and therefore it is not possible to prevent deformation due to changes in humidity, making it difficult to achieve sufficient dimensional stability. Also, if the reinforcing layer 5 is formed on only one surface of the base film 4, when the thickness of the reinforcing layer 5 exceeds 120 nm, the magnetic tape 1 becomes prominently curled. Accordingly, the thickness of the reinforcing layer 5 should preferably be set in a range of 40 nm to 120 nm, inclusive. In the present embodiment, the thickness of the reinforcing layer 5 is set at around 80 nm as one example.

The reinforcing layer 5 is subjected to a surface treatment that applies external energy to the surface on which the back coat layer 6 will be formed. As the surface treatment that applies external energy, it is possible to carry out one of corona discharge treatment, plasma treatment, UV beam treatment, and electron beam treatment. By carrying out any of such treatments, it is possible to reliably improve the bonding characteristics of the surface of the reinforcing layer 5. Here, the expression “corona discharge treatment” refers to a process that subjects the reinforcing layer 5 to corona discharge. The expression “plasma treatment” refers to a process that subjects the reinforcing layer 5 to glow discharge that occurs in low-pressure gas of 10⁻² mmHg to 10 mmHg, or an atmospheric-pressure plasma treatment that uses atmospheric-pressure glow discharge. The expression “UV beam treatment” refers to a process that applies a UV beam to the reinforcing layer 5, while the expression “electron beam treatment” refers to a process that applies an electron beam to the reinforcing layer 5. By subjecting the reinforcing layer 5 to the surface treatment, it is possible to increase the bonding characteristics for the functional layers described above that are formed on the treated surface of the reinforcing layer 5.

Also, although the reinforcing layer 5 is provided on only one surface of the base film 4 of the magnetic tape 1 shown in FIG. 1 (the formation surface of the back coat layer 6 in FIG. 1), reinforcing layers 5 may be provided on both surfaces as with a magnetic tape 11 shown in FIG. 2. By forming the reinforcing layers 5 on both surfaces of the base film 4 like the magnetic tape 11, stress due to the reinforcing layers 5 cancels out, making it possible to reduce curling of the magnetic tape 11. Also by providing the reinforcing layers 5 on both surfaces of the base film 4, it is possible to effectively suppress the permeation of moisture. Note that aside from an extra reinforcing layer 5 being formed between the base film 4 and the non-magnetic layer 2, the magnetic tape 11 has the same construction as the magnetic tape 1, and therefore parts that are the same as in the magnetic tape 1 have been assigned the same reference numerals and duplicated description thereof has been omitted.

Back Coat Layer

The back coat layer 6 is provided as necessary to improve the running stability and to prevent the magnetic tape 1 from becoming electrically charged. Although there are no particular limitations on the structure or composition, as one example, it is possible to form the back coat layer 6 so as to include carbon black, non-carbon black non-magnetic inorganic powder, and a binder. Here, the back coat layer 6 should preferably include 30% by weight to 80% by weight of carbon black. As the non-carbon black non-magnetic inorganic powder, it is possible to use acicular non-magnetic iron oxide (such as α-Fe₂C₃ or α-FeOOH), CaCO₃, TiO₂, BaSO₄, α-Al₂O₃, or the like, and by doing so, it is possible to control the mechanical strength of the back coat layer 6 to a desired value.

The coating composition (back coat layer coating composition) for forming the back coat layer 6 is prepared according to a well-known method by adding an organic solvent to the substances described above and carrying out processes such as mixing, agitating, kneading, and dispersing. There are no particular limitations on the organic solvent used, and it is possible to use the same substances used for the non-magnetic layer 2.

The back coat layer 6 is formed with a thickness (after the calendering process) of 1.0 μm or below, and preferably in a range of 0.1 μm to 1.0 μm, inclusive, and more preferably in a range of 0.2 μm to 0.8 μm, inclusive.

Manufacturing the Magnetic Tape 1

First, the reinforcing layer 5 is formed on the second surface of the base film 4 by depositing metal or the like according to vacuum deposition. Next, a surface treatment that applies external energy is carried out on the reinforcing layer 5. After this, by carrying out processes such as coating, drying, calendering, and hardening using the back coat layer coating composition prepared as described above, the back coat layer 6 is formed on the reinforcing layer 5. Next, by using the non-magnetic coating composition and magnetic coating composition prepared as described above and carrying out processes such as coating, drying, calendering, and hardening, the non-magnetic layer 2 and the magnetic layer 3 are formed in the mentioned order on the first surface of the base film 4, thereby manufacturing the magnetic tape 1 shown in FIG. 1.

The non-magnetic layer 2 and the magnetic layer 3 may be formed using a so-called “wet on wet” coating method or a so-called “wet on dry” coating method. In the present embodiment, an example where the layers are formed using a “wet on dry” coating method is described. More specifically, first the non-magnetic coating composition is applied on the first surface of the base film 4, the coating composition is dried, and then a calendering process is carried out as necessary to form the non-magnetic layer 2 in a pre-hardened state. After this, the pre-hardened non-magnetic layer 2 is subjected to 1.0 Mrad to 6.0 Mrad, inclusive of electron beam irradiation to harden the non-magnetic layer 2. Next, after the magnetic coating composition has been applied onto the hardened non-magnetic layer 2, orienting and drying processes are carried out to form the magnetic layer 3.

As the method of applying the non-magnetic coating composition, the magnetic coating composition, and the back coat layer coating composition, a variety of well-known coating methods such as gravure coating, reverse roll coating, die nozzle coating, and bar coating can be used.

In this way, according to the method of manufacturing the magnetic tape 1, by carrying out a surface treatment that applies external energy to the reinforcing layer 5 formed on the base film 4 and forming the back coat layer 6 on the surface of the reinforcing layer 5 that has been subjected to the surface treatment, it is possible to sufficiently improve the bonding characteristics between the reinforcing layer 5 and the back coat layer 6 without forming an adhesion-enhancing layer between the reinforcing layer 5 and the back coat layer 6. This means it is possible to manufacture a magnetic tape 1 where the back coat layer 6 is formed with sufficient bonding strength on the reinforcing layer 5 without an increase in the manufacturing cost or a fall in manufacturing yield.

Also, out of all the functional layers (the non-magnetic layer 2, the magnetic layer 3, and the back coat layer 6), by forming the back coat layer 6 first, even if a process that temporarily winds the base film 4 onto a winding roll is carried out after the reinforcing layer 5 has been formed, since the non-magnetic layer 2 is yet to be formed on the base film 4, it is possible to reliably prevent the lubricant included in the non-magnetic layer 2 from adhering to the surface of the reinforcing layer 5. Accordingly, since it is possible to avoid a situation where the lubricant makes the surface treatment that subsequently applies external energy to the reinforcing layer 5 less effective (i.e., where the lubricant reduces the improvement in bonding characteristics), the back coat layer 6 can be attached to the reinforcing layer 5 with sufficient bonding strength.

### EXAMPLES

The magnetic tape 1 according to the present invention will now be described in detail with reference to examples.

### Example 1

### Preparation of the Non-Magnetic Coating Composition

| Non-Magnetic Powder | | |
|---|---|---|
| Acicular α-Fe₂O₃ | 80 | parts by weight |
| (average major axis length: 0.1 μm, crystallite | | |
| diameter: 12 nm) | | |
| Carbon Black | 20 | parts by weight |
| (Product Name: “#950B” made by Mitsubishi | | |
| Chemical Corp., average particle diameter: | | |
| 17 nm, BET specific surface area: 250 m²/g, | | |
| DBP oil absorption: 70 ml/100 g, pH: 8) | | |
| Electron Beam-Curing Binder | | |
| Electron Beam-Curing Vinyl Chloride Resin | 12.0 | parts by weight |
| (Product name “TB-0246” made by Toybo Co., | | |
| Ltd., (solid content) a copolymer fo vinyl chloride | | |
| and an epoxy-containing monomer, average | | |
| degree of polymerization: 310, content of S based | | |
| on the use of potassium persulfate: 0.6% (percen- | | |
| tage by weight), MR110 (made by Zeon Corpor- | | |
| ation of Japan) acrylic-modified using | | |
| 2-isocyanatoethyl methacrylate (MOI), acrylic | | |
| content: 6 mol/1 mol | | |
| Electron-beam curing polyurethane resin | 10.0 | parts by weight |
| (Product name “TB-0216” made by Toybo Co., | | |
| Ltd., (solid content) hydroxy-containing acrylic | | |
| compound—phosphonate group-containg | | |
| phosphorus compound—hydroxyl-containing | | |
| polyester polyol, average molecular weight: | | |
| 13,000, P content: 0.2% (percentage by weight), | | |
| acryl content: 8 mol/1 mol. | | |
| Dispersant | | |
| Phosphate surfactant | 3.0 | parts by weight |
| (Product name “RE610” made by Toho Chemical | | |
| Industry Co., Ltd.) | | |
| Abrasive Powder | | |
| α-alumina | 5.0 | parts by weight |
| (Product name “HIT60A” made by Sumitomo | | |
| Chemical Co., Ltd., average particle diameter: | | |
| 0.18 μm) | | |
| NV (solid concentration) = | 33% | (percentage |
| | | by mass) |
| Solvent Proportions | | |
| MEK/toluene/cyclohexanone = | 2/2/1 | (ratio by mass) |

After the materials described above have been kneaded by a kneader, the mixture was dispersed using a horizontal pin mill filled with 0.8 mm zirconia beads to a fill ratio of 80% (a void ratio of 50 vol %). After this, the lubricants described below

Lubricant

| | |
|---|---|
| Fatty Acid | 1.0 parts by weight |
| (Product name: “NAA180” made by | |
| NOF Corporation) | |
| Fatty Acid Amide | 0.5 parts by weight |
| (Product name: “Fatty Acid Amide S” made by Kao | |
| Corporation) | |
| Fatty Acid Ester | 1.5 parts by weight |
| (Product name: “NIKKOLBS” made by Nikko | |
| Chemicals Co., Ltd.) | |

were added, and the mixture was diluted to achieve an NV (solid concentration)=25% (percentage by mass)) and solvent proportions of MEK/toluene/cyclohexane 2/2/1 (ratio by mass), and then dispersed. After this, by passing the obtained material through a filter with an absolute filtering accuracy of 3.0 μm, the non-magnetic coating composition was fabricated.

Next, 0.2 parts by weight of a thermal hardener (“Colonate L” made by Nippon Polyurethane Industry Co., Ltd.) are added and mixed into the fabricated non-magnetic coating composition, and by passing the composition through a filter with an absolute filtering accuracy of 1.0 μm, the non-magnetic coating composition for the present invention was fabricated.

Preparation of the Magnetic Coating Composition

| Ferromagnetic Powder | | |
|---|---|---|
| Fe-based Acicular Ferromagnetic Powder | 100.0 | parts by weight |
| (Fe/Co/Al/Y = 100/24/5/8 (atomic ratio), Hc: | | |
| 188 kA/m, σs: 140 Am²/kg, BET specific surface | | |
| area: 50 m²/g, and average major axis length: | | |
| 0.01 μm) | | |
| Binder | | |
| Vinyl Chloride Copolymer | 10.0 | parts by weight |
| (Product name: “MR110” made by Zeon | | |
| Corporation of Japan) | | |
| Polyester Polyurethane | 6.0 | parts by weight |
| (Product name: “UR8300” made by | | |
| Toyobo Co., Ltd.) | | |
| Dispersant | | |
| Phosphate surfactant | 3.0 | parts by weight |
| (Product name: “RE610” made by Toho Chemical | | |
| Industry Co., Ltd.) | | |
| Abrasive Powder | | |
| α-alumina | 10.0 | parts by weight |
| (Product name: “HIT60A” made by Sumitomo | | |
| Chemical Co., Ltd., average particle | | |
| diameter: 0.18 μm) | | |
| NV (solid concentration) = | 30% | (percentage |
| | | by mass) |
| Solvent Proportions | | |
| MEK/toluene/cyclohexanone = | 4/4/2 | (ratio by mass) |

After the materials described above have been kneaded by a kneader, as a first-stage dispersing process, the mixture was dispersed using a horizontal pin mill filled with 0.8 mm zirconia beads to a fill ratio of 80% (a void ratio of 50 vol %).

After this, the mixture was diluted so that NV (solid concentration)=15% (percentage by mass)) and the solvent proportions of MEK/toluene/cyclohexane=22.5/22.5/55 (ratio by mass), before a main (finishing) dispersing process was carried out. Next, after 10 parts by weight of a thermal hardener (“Colonate L” made by Nippon Polyurethane Industry Co., Ltd.) were added and mixed into the obtained coating composition, the composition was passed through a filter with an absolute filtering accuracy of 1.0 μm to fabricate the magnetic coating composition.

Preparation of the Back Coat Layer Coating Composition

| | |
|---|---|
| Carbon Black | 75 parts by weight |
| (Product name: “BP-800” made by Cabot | |
| Corporation, average particle diameter 17 nm, | |
| BET specific surface area 210 m²/g) | |
| Carbon Black | 10 parts by weight |
| (Product name: “BP-130” made by Cabot | |
| Corporation, average particle diameter 75 nm, | |
| DBP oil absorption 69 ml/100 g, BET specific | |
| surface area 25 m²/g) | |
| Barium Sulfate | 15 parts by weight |
| (Product name: “Barifine BF-20” made by Sakai | |
| Chemical Industry Co., Ltd., average particle | |
| diameter 30 nm) | |
| Nitrocellulose | 80 parts by weight |
| (Product name: “BTH ½” made by Asahi Kasei | |
| Corporation) | |
| Polyurethane Resin | 40 parts by weight |
| (Product name: “UR-8300” made by Toyobo Co., | |
| Ltd., containing sodium sulfonate) | |
| MEK | 150 parts by weight |
| Toluene | 150 parts by weight |
| Cyclohexanone | 80 parts by weight |

After sufficiently kneading the composition described above using a kneader, dispersing was carried out for five hours using a sand grind mill. After this, the materials listed below were introduced and dispersing was carried out using a sand grind mill for one hour.

| | |
|---|---|
| MEK | 400 parts by weight |
| Toluene | 400 parts by weight |
| Cyclohexanone | 200 parts by weight |

20 parts by weight of a thermal hardener (“Colonate L” made by Nippon Polyurethane Industry Co., Ltd.) were added and mixed into the mixed solution obtained as described above, and by passing the composition through a filter with an absolute filtering accuracy of 1.0 μm, the back coat layer coating composition was fabricated.

Reinforcing Layer Forming Process

Aluminum (Al) was deposited by vacuum deposition on the second surface of the base film 4 made of PET that is 6.0 μm thick to form the reinforcing layer 5, and then a corona discharge treatment was carried out on the reinforcing layer 5. Here, the reinforcing layer 5 was formed with a thickness of 80 nm. The corona discharge treatment was carried out with an energy density of 80 W/(m²/minute) (400 W, running speed of the base film 4=25 m/minute).

Back Coat Layer Forming Process

The back coat layer coating composition was applied by a nozzle onto the reinforcing layer 5 formed on the second surface of a base film 4 so that the thickness after processing was 0.5 μm, and then subjected to a drying process. After this, calendering was carried out using a calender that is a combination of a plastic roll and a metal roll, where the material was nipped four times, the processing temperature was 90° C., the linear pressure was 2100 N/cm, and the speed was 150 m/min to form the back coat layer 6.

Non-Magnetic Layer Forming Process

The non-magnetic coating composition was applied by being extruded from a nozzle onto a first surface of a base film 4 so that the thickness after the calendering process was 2.0 μm and then dried. After this, calendering was carried out using a calender that is a combination of a plastic roll and a metal roll, where the material was nipped four times, the processing temperature was 100° C., the linear pressure was 3500 N/cm, and the speed was 150 m/min. In addition, 4.0 Mrad of electron beam irradiation was applied to form the non-magnetic layer 2.

Magnetic Layer Forming Process

The magnetic coating composition was applied from a nozzle onto the non-magnetic layer 2 formed as described above so that the thickness after processing was 0.1 μm, and then an orienting process and a drying process were carried out. After this, calendering was carried out using a calender that is a combination of a plastic roll and a metal roll, where the material was nipped four times, the processing temperature was 100° C., the linear pressure was 3500 N/cm, and the speed was 150 m/min to form the magnetic layer 3.

The base film 4 on which the series of processes described above has been completed was wound onto a winding roll, left in that state for 24 hours, thermally hardened for 48 hours at 60° C., and then cut up into ½ (=12.650 mm) inch strips to fabricate samples of the magnetic tape as example 1.

### Examples 2 to 8

Various samples of magnetic tapes were fabricated as examples 2 to 4 in the same way as the example 1 described above except that during the reinforcing layer forming process, as shown in FIG. 3 an electron beam treatment, a UV beam treatment, and a plasma treatment were respectively carried out in place of the corona discharge treatment. In addition, various samples of magnetic tapes were fabricated as examples 5 to 8 in the same way as examples 1 to 4 described above except that during the reinforcing layer forming process, aluminum oxide (AlOₓ) was deposited in place of aluminum. The electron beam irradiation treatment was carried out with 4.0 Mrad as the total amount of radiation (and an acceleration voltage of 200 kV, an electron flow of 18 mA, and a running speed of 40 m/minute for the base film 4). The UV beam irradiation treatment was carried out with luminance intensity of 1800 mW/cm², and an irradiation amount of 500 mJ/cm² (using a single 4 kW high-pressure mercury lamp, a lamp output of 160 W/cm, an irradiation distance 100 mm, and a running speed of 25 m/minute for the base film 4). As the plasma treatment, an atmospheric-pressure plasma treatment was carried out with a voltage of 10 kV and a running speed of 25 m/minute for the base film 4.

### Comparative Examples 1, 2

Samples of magnetic tapes were fabricated as comparative example 1 in the same way as the example 1 described above (i.e., samples where the reinforcing layer 5 is made of aluminum), except that the corona discharge treatment was not carried out during the reinforcing layer forming process. Also, samples of magnetic tapes were fabricated as comparative example 2 in the same way as the example 5 described above (i.e., samples where the reinforcing layer 5 is made of aluminum oxide), except that the corona discharge treatment was not carried out during the reinforcing layer forming process.

Evaluation of the Magnetic Tapes

The various magnetic tape samples were subjected to the evaluation tests described below for the bonding strength of the back coat layer 6.

Evaluation of the Bonding Strength

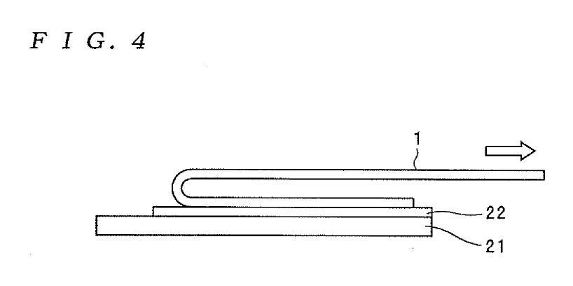

First, the back coat layers 6 of the respective magnetic tape samples were rubbed with the tester's finger and tape samples where the back coat layer 6 easily peeled off were evaluated as having insufficient bonding strength (evaluation results indicated by crosses). Next, as shown in FIG. 4, the formation surface of the back coat layer 6 at one end of a magnetic tape sample (the magnetic tape 1) was stuck to double-sided tape 22 that has been stuck to a metal plate (as one example, an aluminum plate) 21. From this state, the other end of the magnetic tape sample was folded back toward the stuck end and while keeping a part of the magnetic tape sample from the folded back position to the other end parallel to the metal plate 21, the other end of the magnetic tape was pulled in the direction of the arrow in FIG. 4, the pulling force was simultaneously measured, and the state of the back coat layer 6 stuck to the double-sided tape 22 was observed. When doing so, for samples where the back coat layer 6 did not peel off the reinforcing layer 5, the bonding strength of the back coat layer 6 to the reinforcing layer 5 was evaluated as being sufficient (evaluation results shown by circles in FIG. 3), while for samples where the back coat layer 6 peeled off, the bonding strength was evaluated as insufficient (evaluation results shown by crosses in FIG. 3).

The evaluation results of the bonding strength of the examples and the comparative examples are shown in the evaluation result table given in FIG. 3. From these evaluation results, since the back coat layer 6 did not peel off when the back coat layer 6 was rubbed with the tester's finger and the back coat layer 6 did not peel off the reinforcing layer 5 even when the back coat layer 6 was peeled off the double-sided tape 22, it was confirmed that the magnetic tape samples of examples 1 to 8 have sufficient bonding strength. On the other hand, with the magnetic tape samples of the comparative examples 1 and 2, since the back coat layer 6 easily peeled off the reinforcing layer 5 when the back coat layer 6 was rubbed with the tester's finger, it was confirmed that the bonding strength is insufficient. Accordingly, it was confirmed that by forming the back coat layer 6 on the reinforcing layer 5 after the reinforcing layer 5 has been subjected to a surface treatment (a surface treatment that applies external energy) that is one of a corona discharge treatment, an electron beam treatment, a UV beam treatment, and a plasma treatment, the back coat layer 6 is attached to the reinforcing layer 5 with sufficient bonding strength. In addition, it was confirmed that by carrying out the surface treatment described above on the reinforcing layer 5, the back coat layer 6 can be attached to the reinforcing layer 5 with sufficient bonding strength regardless of whether the reinforcing layer 5 is formed of aluminum or aluminum oxide.

It was also confirmed that even if a reinforcing layer 5 is formed on both surfaces of the base film 4 like the magnetic tape 11 shown in FIG. 2, by carrying out a surface treatment that is one of a corona discharge treatment, an electron beam treatment, a UV beam treatment, and a plasma treatment on the reinforcing layer 5 on the back coat layer 6 side, the back coat layer 6 can be attached to the reinforcing layer 5 with sufficient bonding strength in the same way as with the magnetic tape 1. It was also confirmed that the non-magnetic layer 2 is attached to the reinforcing layer 5 on the non-magnetic layer 2 side with sufficient bonding strength even if the surface treatment described above is not carried out and that the non-magnetic layer 2 is attached with an even higher bonding strength if the surface treatment described above is carried out.

What is claimed is:

1. A method of manufacturing a magnetic recording medium, comprising:
forming a reinforcing layer on a first surface of a non-magnetic support;
performing a surface treatment that applies external energy to a surface of the reinforcing layer; and
forming a functional layer on the surface of the reinforcing layer that has been subjected to the surface treatment.

2. A method of manufacturing a magnetic recording medium according to claim 1,
wherein after forming a back coat layer as the functional layer, forming another functional layer on a second surface of the non-magnetic support.

3. A method of manufacturing a magnetic recording medium according to claim 2,
wherein the reinforcing layer is formed using at least one of Al, Cu, Zn, Sn, Ni, Ag, Co, Fe, Mn, and Cr as metals, an oxide of the metals, Si, Ge, As, Sc, and Sb as semimetals, and an oxide of the semimetals.

4. A method of manufacturing a magnetic recording medium according to claim 3,
wherein the reinforcing layer is formed using aluminum oxide as the oxide of the metals.

5. A method of manufacturing a magnetic recording medium according to claim 2,
wherein after forming the reinforcing layer by a vapor phase growth method, performing the surface treatment on the reinforcing layer by carrying out one of corona discharge treatment, plasma treatment, UV beam treatment, and electron beam treatment.

6. A method of manufacturing a magnetic recording medium according to claim 2, comprising:
forming reinforcing layers on both surfaces of a non-magnetic support;
performing a surface treatment that applies external energy on a surface of a reinforcing layer formed on at least a first surface out of both surfaces of the non-magnetic support; and
forming a functional layer on the surface of the reinforcing layer that has been subjected to the surface treatment.

7. A method of manufacturing a magnetic recording medium according to claim 6,
wherein after forming a back coat layer as the functional layer, forming another functional layer on a surface of the reinforcing layer formed on a second surface of the non-magnetic support.
